(19) United States
(12) Patent Application Publication
(10) Pub. No.: US 2026/0129449 A1
(43) Pub. Date: May 7, 2026

(54) A SYSTEM AND METHOD FOR CHANNEL ACCESS IN OPPORTUNISTIC REINFORCEMENT LEARNING-BASED 802.11 NETWORKS

(71) Applicant: BTS KURUMSAL BILISIM TEKNOLOJILERI ANONIM SIRKETI, Atasehir/Istanbul (TR)

(72) Inventors: Mehmet ARIMAN, Sariyer/Istanbul (TR); Lal Verda ÇAKIR, Atasehir/Istanbul (TR); Mehmet ÖZDEM, Çankaya/Ankara (TR); Berk CANBERK, Sariyer/Istanbul (TR); Gökhan YURDAKUL, Üsküdar/Istanbul (TR)

(21) Appl. No.: 19/116,345

(22) PCT Filed: Dec. 29, 2023
(86) PCT No.: PCT/TR2023/051873

§ 371 Date: Mar. 27, 2025

(30) Foreign Application Priority Data
Dec. 22, 2023 (TR) 2023/018028

(51) Int. Cl. H04W 12/08; G06N 3/092

(52) U.S. Cl. CPC H04W 12/08; G06N 3/092

(57) ABSTRACT

The invention relates to an opportunistic reinforcement learning-based system developed for channel access and selection in 802.11 networks, which allows users to improve the quality of service received from the network and a method which enables the system to operate.

### TECHNICAL FIELD

The invention relates to an opportunistic reinforcement learning-based system developed for channel access and selection in 802.11 networks, which allows users to improve the quality of service received from the network and a method which enables the system to operate.

### STATE OF THE ART

802.11 networks are based on the IEEE 802.11 standard. This standard defines data transfer, network security, and other related characteristics in wireless communications. 802.11 networks are widely used, so the communication medium becomes crowded, and ultimately, the quality of service received from the network by the users decreases over time.

For the effective use of resources in 802.11 networks in the state of the art, the density should be distributed subtly and evenly throughout the channels. Different channels need to be assigned to different devices located in close proximity, and this problem is similar to the vertex coloring problem in graphs. Said problem is also called k-coloring problem and is an NP-hard problem to solve. These NP-stiffness (Non-Deterministic Polynomial-Time Hardness) problems also apply to channel selection.

To overcome the computational complexity of the variable medium of a wireless medium, the Access Point (AP) vendor scoring system, vertical frequency selection, and selection-based algorithms are utilized. If APs among said algorithms are especially produced by the same manufacturer, improvements in computation and channel density and an increase in efficiency may be observed. However, the channel selection problem persists for the other 802.11 networks located in the areas where these networks are located.

Another problem arising from the channel density is the interference problem. In dense network regions, data conflicts that occur as a result of many devices trying to use the channel at the same time are called interference. This may degrade wireless network performance, slow down the connection speeds, or cause the connections to drop. In order to avoid this, there are many methods based on broadcast power control. These include centralized mechanisms based on sending data to a central controller, and mechanisms in which different network users exchange data between and decide on the appropriate values. However, the fact that these mechanisms require access points to be controlled by a structure reduces their applicability.

In the state of the art and in order to eliminate the above-mentioned disadvantages, new systems and methods need to be developed.

### SUMMARY OF THE INVENTION

The present invention relates to an opportunistic reinforcement learning-based system developed for channel access and selection in 802.11 networks, which allows users to improve the quality of service received from the network and a method which enables the system to operate, in order to eliminate the above-mentioned disadvantages and provide the relevant technical field with new advantages.

The invention detects the channel expected to have a minimum density between the channels by collecting data from the medium using an opportunistic reinforcement learning-based system and a method that ensures the operation of the system and increases the quality of service received from the networks/network by the users.

The system and method of the invention allow the networks located around, which may operate in the 802.11 network and communicate in the same medium to evaluate the opportunities arising from the operating mechanisms.

The opportunistic reinforcement learning-based channel selection controller included in the system of the invention reduces the computational complexity in the networks and increases the required correct channel selection success.

### DESCRIPTION OF THE DRAWINGS

Embodiments of the present invention which are briefly summarized above and discussed in more detail below, may be understood by referring to the exemplary embodiments of the invention illustrated in the accompanying drawings. It should be noted, however, that the accompanying drawings only depict typical embodiments of this invention and are not to be construed as limiting the scope thereof.

FIG. 1. is a representative view of a diagram showing the operation principle of the invention.

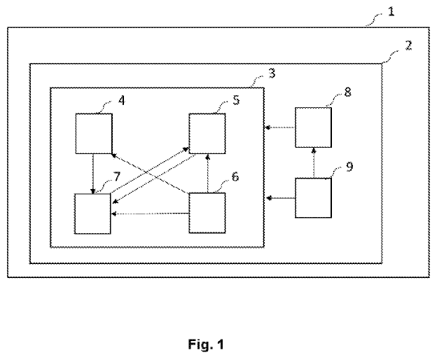

FIG. 2. is a representative view of a diagram showing the principle of operation of the method according to the invention.

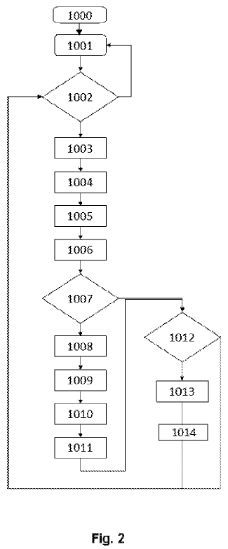

### DESCRIPTION OF THE REFERENCES IN THE DRAWINGS

In order to provide a better understanding of the invention, the numerals in the drawings are provided below:
1. Device
2. Controller
3. Software Module
4. Rule Network Module
5. Destination Network Module
6. Optimization Module
7. Data Storage Unit
8. Calculation Module
9. Status Module
1000. Initiating a training process by the software module, which is a deep Q network agent, and creating the rule network module, the destination network module and the data storage unit
1001. Determining the network training repetition limit and equating the network training repetition counter to 0
1002. Checking whether the network training counter value is greater than the network training repetition limit
1003. Generating status data (sₜ) by the status module, inputting the status data (sₜ) to the rule network, selecting an action by discovery or exploit, and transmitting the selected action data to the medium
1004. Calculating the reward received in response to the action applied by the reward calculation module,
1005. Generating new status data by the status module,
1006. Recording the status, action, reward and new status data in the data storage unit and generating the number of samples by increasing the network training repetition counter by 1
1007. Checking the number of samples in the data storage unit
1008. If there are enough samples, taking a batch of samples from the data storage unit
1009. Inputting the samples taken to the rule network module and the destination network module
1010. Calculating the mean square difference using the outputs of the rule network module and destination network modules
1011. Transferring the average square difference to the optimization module and updating the rule network module in the optimization module
1012. Checking whether the training of the rules network module and the network training repetition limit have been completed,
1013. If completed, transferring the weights in the rule net module to the destination network module
1014. Completing the training of the software module, which is the Deep Q Network Agent, and new channel selection and access in the destination network module by the controller.

### DETAILED DESCRIPTION OF THE INVENTION

Exemplary embodiments are described in more detail below with reference to the accompanying descriptions. However, embodiments may be constructed in different forms and should not be construed as limited to the embodiments set forth herein. Instead, these exemplary embodiments are provided for the completeness of this disclosure and to fully convey its scope to those skilled in the art.

The invention is an opportunistic reinforcement learning-based system with computer-aided machine learning that includes at least one processor, which is developed for channel access and selection in 802.11 networks and allows users to improve the quality of service received from the network, characterized in that it comprises:
at least one device (1) which is located in an 802.11 network and communicates over that network,
at least one channel selection controller (2) based on opportunistic reinforcement learning, which provides data transmission in wireless communication and performs channel selection between the networks,
at least one software module (3), which is a deep Q network (DQN) agent performing an action selection to carry out the channel selection,
at least one rule network module (4), which is a deep neural network, inputting a medium status and estimating the probabilities for each action,
at least one destination network module (5) which avoids the blocking of the evaluation of the updated network arising from the successive implementation of the actions applied to the medium,
at least one optimization module (6) which allows the weights of the destination network module (5) to be optimized,
at least one data storage unit (7), which is an experience memory unit in which the actions taken by the software module (3), which is a DQN agent, the rewards obtained, and the situations obtained by the medium in response to the action are recorded,
at least one reward calculation module (8) which calculates the success (reward) of the channel (action) to be selected considering the channel density in data transmission,
at least one status module (9), which generates status data using the device's (1) location data in the second and third dimensions, timestamp data, and signal values read from the channels.

The device contained in the system of the invention is, but not limited to, a smartphone, a computer, a tablet and similar wireless clients.

The invention is a method for operating an opportunistic reinforcement learning-based system with computer-aided machine learning that includes at least one processor, which is developed for channel access and selection in 802.11 networks and allows users to improve the quality of service received from the network, characterized in that it comprises the following process steps:
initiating a training process by the software module (3), which is a deep Q network agent, and creating the rule network module (4), the destination network module (5) and the data storage unit (7) (1000),
Determining the network training repetition limit and equating the network training repetition counter to 0 (1001),
Checking whether the network training counter value is greater than the network training repetition limit (1002),
Generating status data (sₜ) by the status module (9), inputting the status data(s) to the rule network, selecting an action by discovery or exploit, and transmitting the selected action data to the medium (1003),
Calculating the reward received in response to the action applied by the reward calculation module (8) (1004),
Generating new status data by the status module (9) (1005),
Recording the status, action, reward and new status data in the data storage unit (7) and generating the number of sample by increasing the network training repetition counter by 1 (1006),
Checking the number of samples in the data storage unit (7) (1007),
If there are enough samples, taking a batch of samples from the data storage unit (7) (1008),
Inputting the samples taken to the rule network module (4) and the destination network module (5) (1009),
Calculating the mean square difference using the outputs of the rule network module (4) and destination network modules (5) (1010),
Transferring the average square difference to the optimization module (6) and updating the rule network module (4) in the optimization module (6) (1011),
Checking whether the training of the rules network module (4) and the network training repetition limit has been completed (1012),
If it has been completed, transfer the weights in the rule network module (4) to the destination network module (5) (1013), or if the training has not been completed, check whether the network training counter value is greater than the network training repetition limit (1002),
completing the training of the software module (3), which is the Deep Q Network Agent and new channel selection and access in the destination network module (5) by the controller (2) (1014).

In each training cycle of the invention, the software module (3), which is the deep Q network agent, selects an action using the status information generated by the status module (9).

In step 1003 of the invention, a discovery- or exploit-based action selection is carried out. If a discovery process is to be made, a random action is selected. If an exploit process is to be made, the highest probability corresponding to the actions produced by the destination network module (5) by inputting the status information is selected. Said discovery and exploit mechanism is a method used to train the network. Thus, when an exploit process is carried out, the system is able to perform more stable and to gain and learn experiences that it did not have before during the exploit process.

In step 1006 of the invention, the counter starts from 0 and the counter increases by 1 in each cycle during recording the status, action, reward and new status data in the data storage unit (7) and generating the number of sample by increasing the network training repetition counter by 1, and the cycle stops when the network training repetition limit in the step 1001 of the invention is reached.

The criterion of sufficient sample mentioned in step 1008 of the invention is an adjustable parameter.

The Mean Squared Error (MSE) formula is used to calculate the mean square difference using the outputs of the rule network module (4) and destination network modules (5) mentioned in step 1010 of the invention.

In the software module (3), which is a deep Q network agent, the training phase is used in inference mode after completing the method steps given above. In the software module (3), which is a deep Q network agent running in inference mode, only the destination network module (5) is used, and the action selection is carried out according to the highest value among the probabilities calculated using the status. The model used in the inference mode is able to exhibit a stable performance as it does not make a discovery.

In a medium in which a plurality of 802.11 networks are located, the device (1) inside an 802.11 network needs to communicate. The channel assignments of the other networks herein are carried out by a channel selection mechanism based on the scoring systems of the manufacturers. In this case, the device (1) contains an opportunistic reinforcement learning-based channel selection controller (2) to select the channel to be used during communication. The opportunistic reinforcement learning-based channel selection controller (2) may select the most appropriate channel by identifying the opportunities arising from the channel selection mechanism applied by the other networks using the method of the invention.

In the system and the method that enables the system to operate according to the invention, the opportunistic reinforcement learning-based channel selection controller (2) tries to select the most appropriate channel in response to the status information of the medium, using the software module (3), which is a deep Q network agent.

In an embodiment of the invention, the software module (3) includes, but not limited to, two deep Q networks, namely the rule network module (4) and the destination network module (5).

The optimization module (6) performs an optimization process using the Formula 1 given below. The said formulation R(.) is calculated by the reward calculation module (8) and (γ) herein is used to place the importance given to the rewards during the optimization.

$$L ( θ ) = E [ R ( {s}_{t} , {a}_{t} ) + γ {max}_{a ∈ A} TN ( {s}_{t - 1} , {a}_{t - 1} , {θ}^{1} ) - {PN ( {s}_{t} , {a}_{t} , θ )}^{2} ] \qquad Formula 1$$

The rule network module (4) is expressed as PN(sₜ, aₜ, θ), where (sₜ) is the status of the medium at a time t, (aₜ) is an action applied to the medium at a time t, (θ) is a matrix containing the weights of the connections of the network, and L(θ) is the loss function used during the optimization. The status data (sₜ) is input to the network, and said process is generated by the status module (9). The status module (9) generates the status data (sₜ) using the device's (1) latitude, longitude, altitude and time stamp, the selected channel and the signal strength of the channel. Said status module (9) may obtain the status model even if the movement of the device (1) takes place in both two dimensions and three dimensions. In addition, the hidden layers are activated by the rectified linear unit function (ReLu), and the output layer outputs the probabilities according to the reward that can be obtained if they are applied to the medium for each action. These actions include the channels in the 802.11 spectrums which may be used by the device (1) and the actions that mean waiting if all channels are occupied.

In the formula given above, the destination network module (5) is expressed as TN(sₜ₋₁,aₜ₋₁,θ′). The destination network module (5) has the same structure as the rule network module (4), and the connection weights (θ′) of the network may differ. In addition, in the training phase which is the method of the invention, these modules are optimized by the optimization module (6). At least one software module (3), which is also a deep Q network (DQN) agent, includes a data storage unit (7), where previous experiences are kept as (sₜ, aₜ, R(sₜ, aₜ), sₜ₊₁) and used in the training phase for a more stable operation of the model. The data storage unit (7) keeps the previous experiences in random bundles.

In step 1004 of the method of the invention, the reward calculation module (8) calculates the reward using the empirically generated Formula 2 given below, based on the previously observed reward trend. In the said formula, C is the selected channel, A is the channel next to the selected channel, RSSI(.) is the power indicator of the signal read from the channel, dB is decibel, and Q and B are the notations assigned in the system and method.

$$Reward = Q + N + B \qquad Formula 2$$

$$Q = \{ \begin{matrix}0 , & if 0 dB \leq RSSI ( C ) < - 30 dB \\ 5 , & if - 30 dB \leq RSSI ( C ) < - 67 dB \\ 20 , & if - 67 dB \leq RSSI ( C ) < - 80 dB \\ 24 , & if - 80 dB \leq RSSI ( C ) < - 90 dB \\ 30 , & if - 90 dB \leq RSSI ( C ) < - 120 dB\end{matrix} \}$$

$$N = \{ \begin{matrix}0 , & if 0 dB \leq RSSI ( N ) < - 67 dB \\ \frac{Q}{2} , & if - 67 dB \leq RSSI ( N ) < - 80 dB \\ Q - 2 , & if - 80 dB \leq RSSI ( C ) < - 120 dB\end{matrix} \}$$

$$B = \{ \begin{matrix}15 , & if RSSI ( C ) = MIN ( RSSI ) \\ 0 , & otherwise\end{matrix} \}$$

All modules in the system and method of the invention perform the processes mentioned in the invention through the processor included in the computer via a software.

The problem of channel selection persists for the other 802.11 networks located in the areas where the networks in the state of the art are located. The invention overcomes said problem by making use of the less occupied channels in the spectrum arising from the use of the said mechanism.

Any features described in this specification (including attached claims, abstract and drawings) may be replaced by other alternative features that may have equivalent or similar purposes, unless expressly stated otherwise. That is, unless explicitly stated otherwise, each feature is only one instance of a set of equivalent or similar features.

The terminology used in this specification is intended to be used only to describe a specific exemplary embodiment and is not intended to be restrictive. As used herein, the context of the forms “one”, “at least”, “preferably” and “and/or” also includes plural forms unless expressly stated otherwise. When the terms “contains” and/or “including” are used in this specification, they include the presence or addition of specified properties, integers, steps, operations, elements, and/or components, but do not preclude one or more other features, integers, steps, operations, elements, and/or components.

The above embodiments are intended only to describe the technical concept and characteristics of the present invention, and the object of the present invention is to enable the skilled one in the art to understand the content of the present invention and implement the present invention, and the scope of the present invention is not limited thereto. Equivalent alterations or modifications made in accordance with the spirit of the invention are intended to be included in the scope of the invention.

### INDUSTRIAL APPLICABILITY OF THE INVENTION

The invention relates to an opportunistic reinforcement learning-based system developed for channel access and selection in 802.11 networks, which allows users to improve the quality of service received from the network and a method which enables the system to operate, and has an industrial applicability.

The invention is not limited to the above exemplary embodiments, and a person skilled in the art may easily present other different embodiments of the invention. These should be considered within the scope of protection of the invention claimed in the claims.

1. An opportunistic reinforcement learning-based system with computer-aided machine learning that includes at least one processor, which is developed for channel access and selection in 802.11 networks and allows users to improve the quality of service received from the network, characterized in that it comprises:
at least one device (1) which is located in an 802.11 network and communicates over that network,
at least one channel selection controller (2) based on opportunistic reinforcement learning, which provides data transmission in wireless communication and performs channel selection between the networks,
at least one software module (3), which is a deep Q network (DQN) agent performing an action selection to carry out the channel selection,
at least one rule network module (4), which is a deep neural network, inputting a medium status and estimating the probabilities for each action,
at least one destination network module (5) which avoids the blocking of the evaluation of the updated network arising from the successive implementation of the actions applied to the medium,
at least one optimization module (6), which allows the weights of the destination network module (5) to be optimized,
at least one data storage unit (7), which is an experience memory unit in which the actions taken by the software module (3), which is a DQN agent, the rewards obtained, and the situations obtained by the medium in response to the action are recorded,
at least one reward calculation module (8) which calculates the success (reward) of the channel (action) to be selected considering the channel density in data transmission,
at least one status module (9), which generates status data using the device's (1) location data in the second and third dimensions, timestamp data, and signal values read from the channels.

2. A method for operating an opportunistic reinforcement learning-based system with a computer-aided machine learning that includes at least one processor, which is developed for channel access and selection in 802.11 networks and allows users to improve the quality of service received from the network, characterized in that it comprises the steps of:
initiating a training process by the software module (3), which is a deep Q network agent, and creating the rule network module (4), the destination network module (5) and the data storage unit (7) (1000),
determining the network training repetition limit and equating the network training repetition counter to 0 (1001),
checking whether the network training counter value is greater than the network training repetition limit (1002),
generating status data (sₜ) by the status module (9), inputting the status data sₜ) to the rule network, selecting an action by discovery or exploit, and transmitting the selected action data to the medium (1003),
calculating the reward received in response to the action applied by the reward calculation module (8) (1004),
generating new status data by the status module (9) (1005),
recording the status, action, reward and new status data in the data storage unit (7) and generating the number of samples by increasing the network training repetition counter by 1 (1006),
checking the number of samples in the data storage unit (7) (1007),
if there are enough samples, take a batch of samples from the data storage unit (7) (1008),
inputting the samples taken to the rule network module (4) and the destination network module (5) (1009),
calculating the mean square difference using the outputs of the rule network module (4) and destination network modules (5) (1010),
transferring the average square difference to the optimization module (6) and updating the rule network module (4) in the optimization module (6) (1011),
checking whether the training of the rules network module (4) and the network training repetition limit has been completed (1012),
if it has been completed, transferring the weights in the rule network module (4) to the destination network module (5) (1013), or if the training has not been completed, checking whether the network training counter value is greater than the network training repetition limit (1002),
completing the training of the software module (3), which is the Deep Q Network Agent and new channel selection and access in the destination network module (5) by the controller (2) (1014).

3. A method as claimed in claim 2, characterized by comprising randomly selecting an action by discovery, or selecting the highest probability of the actions produced in response to the input of the destination module (5) status information.

4. A method as claimed in claim 3, characterized by calculating the mean square difference using the outputs of the rule network module (4) and destination network modules (5) according to the Mean Squared Error (MSE) formula.

5. A method as claimed in claim 4, characterized in that upon completion of the training phase, the destination network module (5) and the software module (3), which is a deep Q network agent, operates in an inference mode.
